(19) United States
(12) Patent Application Publication
(10) Pub. No.: US 2006/0146241 A1
(43) Pub. Date: Jul. 6, 2006

(54) Vertically aligned mode liquid crystal display

(76) Inventors: Young-Min Choi, Seoul (KR); Jang-kun Song, Seoul (KR); Jin-Yun Kim, Yongin-city (KR)

Correspondence Address: MACPHERSON KWOK CHEN & HEID LLP, 1762 TECHNOLOGY DRIVE, SUITE 226, SAN JOSE, CA, 95110, US

(21) Appl. No.: 10/521,397

(22) PCT Filed: Sep. 19, 2002
(86) PCT No.: PCT/KR02/01782

§ 371 Date: Sep. 26, 2005

(30) Foreign Application Priority Data
Jul. 19, 2002 (KR) 2002/42658

(51) Int. Cl. G02F 1/1337

(52) U.S. Cl. 349/129

(57) ABSTRACT

A liquid crystal display is provided, which includes a first insulating substrate; a gate line formed on the first insulating substrate; a gate insulating layer formed on the gate line; a data line formed on the gate insulating layer, a passivation layer formed on the data line; a pixel electrode formed on the passivation layer and a first cutout pattern; a second insulating substrate facing the first insulating substrate; and a common electrode formed on the second insulating substrate and having a second cutout pattern, wherein width of the domains is equal to or less than 30 microns

### BACKGROUND OF THE INVENTION

(a) Field of the Invention

The present invention relates to a vertically aligned mode liquid crystal display, and, in particular, to a vertically aligned mode liquid crystal display including an electrode with cutouts for securing wide viewing angle.

(b) Description of Related Art

A typical liquid crystal display (“LCD”) includes an upper panel with a reference electrode and color filters, a lower panel with thin film transistors (“TFTs”) and pixel electrodes and a liquid crystal layer with dielectric anisotropy interposed therebetween, and displays desired images by applying different voltages to the reference electrode and the pixel electrodes to generate electric field in the liquid crystal layer, which changes the orientations of liquid crystal molecules to control the light transmittance.

Among these LCDs, a vertically aligned mode LCD (referred to as a “VALCD” hereinafter), which aligns the major axes of the liquid crystal molecules vertical to upper and lower panels in absence of electric field, is promising because of its high contrast ratio and wide viewing angle.

To implement wide viewing angle in the VALCD, a cutout pattern or protuberances are provided on the electrode. Both generate fringe field to regularly distribute tilt directions of the liquid crystal molecules into four directions, thereby giving wide viewing angle. A patterned-vertically-aligned (PVA) mode LCD including cutout patterns among these LCDs is recognized as a substitute wide viewing angle technology of an in-plane-switching (IPS) mode LCD.

The PVA mode LCD has relatively fast response time compared with a twisted nematic (TN) LCD since the behavior of the liquid crystal molecules is not twisted and includes only elastic motions such as splay or bent in a direction perpendicular to field direction. However, the maturity of the LCD TV market requires a response time faster than the current response time of 25 ms. The response time may be increased as the dielectric anisotropy becomes higher to induce stronger electric field into the liquid crystal molecules. It is known that the response time becomes shorter as the rotational viscosity becomes low since the lower viscosity reduces the behavior of the liquid crystal molecules and the restoring time upon removal of the electric field. Accordingly, although several techniques for improving the response time by adjusting liquid crystal material are suggested, the liquid crystals having negative dielectric anisotropy has a limitation to improvement of the dielectric anisotropy and reduction of rotational viscosity. Therefore, the improvement of the response time by means of improvement of liquid crystal material is limited.

### SUMMARY OF THE INVENTION

A motivation of the present invention is to improve response time of an LCD.

To accomplish these and other motivation, the present invention optimizes the width of electrodes and cutouts. The width of the cutouts for generating fringe field basically satisfies a relation (width of cutouts)/ (cell gap)≧1.0.

In detail, a thin film transistor array panel for liquid crystal display is provided, which includes: a first insulating substrate; a gate line formed on the first insulating substrate; a gate insulating layer formed on the gate line; a data line formed on the gate insulating layer; a passivation layer formed on the data line; a pixel electrode formed on the passivation layer; a second insulating substrate facing the first insulating substrate; a common electrode formed on the second insulating substrate; a first domain partitioning member formed on at least one of the first and the second insulating substrates; and a second domain partitioning member formed on at least one of the first and the second insulating substrates and partitioning a pixel region into a plurality of domains along with the first domain partitioning member, wherein width of the domains is equal to or less than 30 microns.

The width of the domains is preferably equal to or less than 28 microns, 22 microns, or 17 microns.

The first domain partitioning member may include a cutout provided at the pixel electrode and the second domain partitioning member may include a cutout provided at the common electrode. The width of the second domain partitioning member is preferably equal to or less than 24 microns or 5 microns. Extension of the domains preferably makes an angle of 45 degrees or 135 degrees with the gate line. The data line may have a triple-layered structure including an amorphous silicon layer, a doped amorphous silicon layer, and a metal layer.

A liquid crystal display is provided, which includes: a first insulating substrate; a gate wire formed on the first insulating substrate and including a gate line, a gate electrode connected to the gate line, and a gate pad connected to the gate line; a storage electrode wire formed on the first insulating substrate and including a storage electrode line and a storage electrode branched from the storage electrode lines; a gate insulating layer formed on the gate wire and the storage electrode wire; an amorphous silicon layer formed on the gate insulating layer; a contact layer formed on the amorphous silicon layer; a data wire formed on the contact layer and including a data line intersecting the gate line, a data pad connected to the data line, a source electrode connected to the data line and located adjacent to the gate electrode, and a drain electrode located opposite the source electrode with respect to the gate electrode; a passivation layer formed on the data wire; a pixel electrode formed on the passivation layer, connected to the drain electrode, and having a first cutout pattern; facing the first insulating substrate; a black matrix formed on the second insulating layer and defining a pixel area; a color filter formed on the pixel area; and a common electrode formed on the color filter and having a second cutout pattern, wherein width of the second cutout pattern is equal to or less than 24 microns.

The liquid crystal display further includes a liquid crystal layer interposed between the first insulating substrate and the second insulating substrate, wherein liquid crystal molecules included in the liquid crystal layer are aligned perpendicular to the first insulating substrate in absence of electric field. The width of the second cutout pattern is preferably equal to or less than 5 microns, and the width of the first and the second cutout patterns is equal to or less than cell gap of the liquid crystal layer. The first and the second cutout patterns preferably partition a pixel region into a plurality of domains, and the width of the domains is equal to or less than 28 microns, 22 microns, and 17 microns. Preferably, the liquid crystal display further includes an overcoat interposed between the color filter and a common electrode.

### BRIEF DESCRIPTION OF THE DRAWINGS

FIG. 1 is a layout view of a TFT array panel for an LCD according to a first embodiment of the present invention;

FIG. 2 is a layout view of a color filter panel for an LCD according to the first embodiment of the present invention;

FIG. 3 is a layout view of an LCD according to the first embodiment of the present invention;

FIG. 4 is a sectional view taken along the line IV-IV′ in FIG. 3;

FIG. 5 is a graph showing response characteristic depending on electrode distance (i.e., width of domains) in a PVA mode LCD;

FIG. 6 is a graph showing response time for electrode width (i.e., width of the domains);

FIG. 7 is a graph representing ON cusp position depending on electrode width (i.e., width of the domains);

FIG. 8 is a graph showing response time of texture for electrode width (i.e., width of the domains);

FIG. 9 is a graph showing the second transmissive efficiency depending on electrode distance (i.e., width of domains);

FIG. 10 shows the third transmissive efficiency depending on electrode distance (i.e., width of domains);

FIG. 11 is a graph showing response characteristics as function of the width of cutouts of a common electrode in a PVA mode LCD;

FIG. 12 is a graph showing the transmittance as function of the width of cutouts of a common electrode in a PVA mode LCD;

FIGS. 13 to 17 are sectional views of a TFT array panel for an LCD sequentially showing the steps of a manufacturing method thereof using five masks; and

FIGS. 18A and 18B to FIGS. 26A and 26B are sectional views of a TFT array panel for an LCD sequentially showing the steps of a manufacturing method thereof using four masks.

### DETAILED DESCRIPTION OF PREFERRED EMBODIMENTS

Embodiments of the present invention will be described in detail with reference to accompanying drawings for those skilled in the art to practice easily. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, film, region, substrate or panel is referred to as being “on” another element, it can be directly on the other element or intervening elements may also be present In contrast, when an element is referred to as being “directly on” another element, there are no intervening elements present

Then, thin film transistor array panels for liquid crystal displays according to embodiments of the present invention will be described with reference to the drawings.

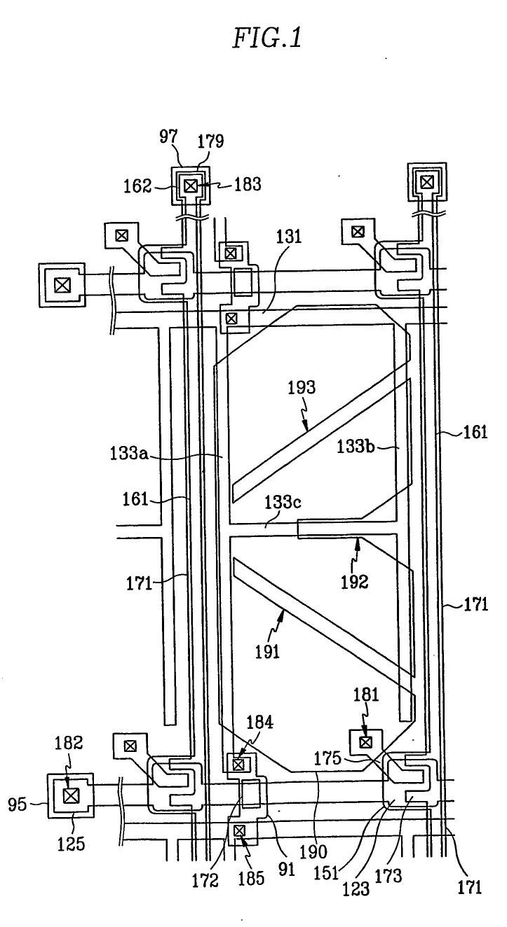

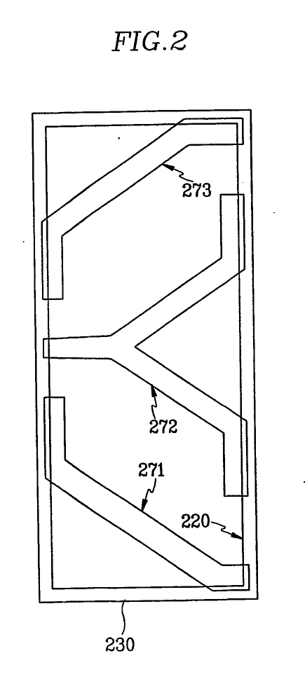

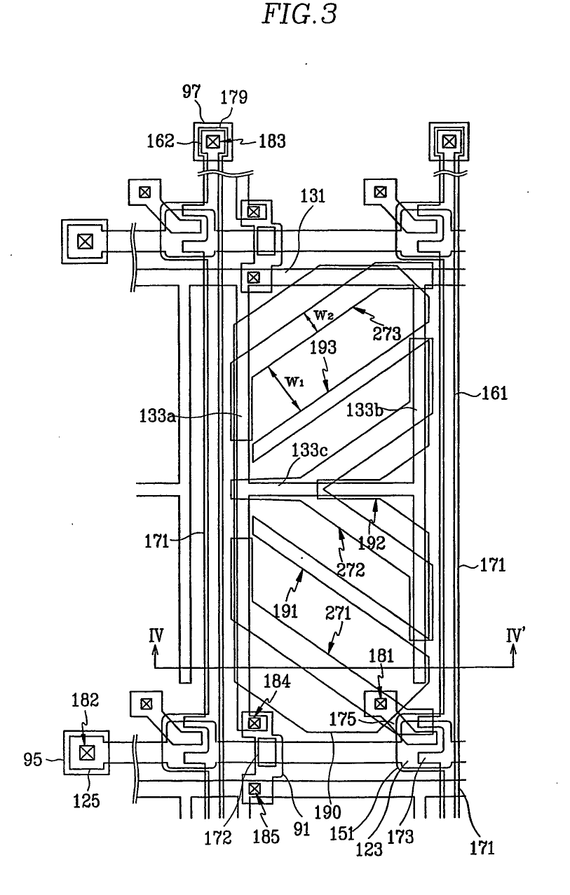

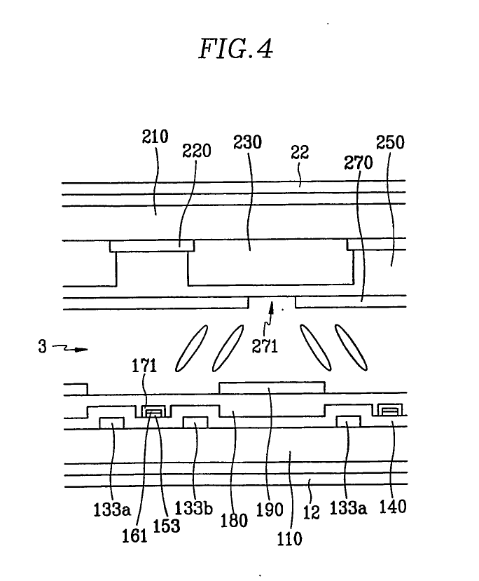

FIG. 1 is a layout view of a TFT array panel for an LCD according to a first embodiment of the present invention, FIG. 2 is a layout view of a color filter panel for an LCD according to the first embodiment of the present invention, FIG. 3 is a layout view of an LCD according to the first embodiment of the present invention, and FIG. 4 is a sectional view taken along the line IV-IV′ in FIG. 3.

An LCD includes a lower substrate 110, an upper substrate 210 opposite thereto and a liquid crystal layer 3 interposed between the substrates 110 and 210 and including liquid crystal molecules aligned vertical to the substrates 110 and 210.

A plurality of pixel electrodes 190 are formed on an inner surface of the lower substrate 110 preferably made of transparent insulating material such as glass. The pixel electrodes 190 are preferably made of transparent conductive material such as ITO (indium tin oxide) and IZO (indium zinc oxide) and have a plurality of cutouts 191, 192 and 193. The respective pixel electrodes 190 are connected to TFTs to be applied with image signal voltages. The TFTs are connected to a plurality of gate lines 121 transmitting scanning signals and a plurality of data lines 171 transmitting image signals, to be turned on or off in response to the scanning signals. A lower polarizer 12 is attached on an outer surface of the lower substrate 110. For a reflective LCD, the pixel electrodes 190 are not made of transparent material, and the lower polarizer 12 is unnecessary.

A black matrix 220 for blocking light leakage, a plurality of the red, green and blue color filters 230 and a reference electrode 270 preferably made of transparent conductive material such as ITO and IZO are formed on an inner surface of the upper substrate 210 preferably made of transparent insulating material such as glass. A plurality of cutouts 271, 272 and 273 are provided on the reference electrode 270. Although the black matrix 220 overlaps the boundaries of pixel areas, it may further overlap the cutouts 271, 272 and 273 of the reference electrode 270 in order for blocking light leakage generated by the cutouts 271, 272 and 273.

An LCD according to the first embodiment will be described more in detail.

A plurality of gate lines 121 extending substantially in a transverse direction are formed on a lower insulating substrate 110. A plurality of expansions of each gate line 121 form a plurality of gate electrodes 123 and an end of each gate line 121 forms a gate pad 125. A plurality of storage electrode lines 131 extending substantially parallel to the gate lines 121 are also formed on the insulating substrate 110. A plurality of pairs of storage electrodes 133a and 133b extending in a longitudinal direction are branched from each storage electrode line 131 are connected to each other via a storage electrode 133c extending in the transverse direction. The number of the storage electrode lines 131 may be two or more. The gate lines 121, the gate electrodes 123, the storage electrode lines 131 and the storage electrodes 133 are preferably made of metal such as Al or Cr. They include either a single layer or double layers preferably including sequentially deposited Cr and Al layers. Alternatively, they include a variety of metals.

A gate insulating layer 140 preferably made of SiNx is formed on the gate lines 121, the storage electrode lines 131 and the storage electrodes 133.

A plurality of data lines 171 extending in the longitudinal direction are formed on the gate insulating layer 140. A plurality of branches of each data line 171 form a plurality of source electrodes 173 and a plurality of drain electrodes 175 are formed adjacent to the respective source electrodes 173. In addition, a plurality of under-bridge metal pieces 172 overlapping the gate lines 121 are formed on the gate insulating layer 140. The data lines 171, the source electrodes 173 and the drain electrodes 175 are preferably made of Cr or Al like the gate wire. They may also have a single-layered structure or a multiple-layered structure.

A plurality of channel portions 151 of a amorphous silicon layer 151 and 153 used as channel portions of TFTs are formed under the source electrodes 173 and the drain electrodes 175, and a plurality of data portions 153 of the amorphous silicon layer 151 and 153 extending in the longitudinal direction and connecting the semiconductor channel portions 153 are formed under the data lines 171. A contact layer 161 for reducing the contact resistance between the source and the drain electrodes 173 and 175 and the semiconductor channel portions 151 is formed on the amorphous silicon layer 151 and 153. The amorphous silicon layer 151 and 153 is preferably made of amorphous silicon, and the contact layer 161 is preferably made of amorphous silicon heavily doped with N-type impurity.

A passivation layer 180 preferably made of inorganic insulator such as SiNx or organic insulator such as resin is formed on the data lines 171 and the like. A plurality of contact holes 181 exposing the drain electrodes 175 are provided in the passivation layer 180.

A plurality of pixel electrodes 190, each having a plurality of cutouts 191, 192 and 193, are formed on the passivation layer 180. The pixel electrodes 190 are preferably made of a transparent conductor such as ITO or IZO or an opaque conductor having an excellent light-reflecting characteristic such as Al. The cutouts 191, 192 and 193 on each pixel electrode 190 include a transverse cutout 192 extending in the transverse direction and located at a position so as to partition the pixel electrode 190 into upper and lower halves arranged in the longitudinal direction, and two oblique cutouts 191 and 193 extending in oblique directions and located respectively in the lower and the upper halves of the pixel electrodes 190. The extensions of the oblique cutouts 191 and 193 are perpendicular to each other in order for regularly distributing the field directions of the fringe fields into four directions.

In addition, a plurality of storage connections or bridges 91, which connect the storage electrodes 133a to the storage electrode lines 131 opposite thereto with respect to the gate lines 121, are formed on the passivation layer 180. The storage bridges 91 contact the storage electrodes 133a and the storage electrode lines 131 via a plurality of contact holes 183 and 184 provided both in the passivation layer 180 and the gate insulating layer 140. The storage bridges 91 overlap the under-bridge metal pieces 172. The storage bridges 91 electrically connect all the storage wire on the lower substrate 110. This storage wire, if necessary, may be used for repairing the defects of the gate lines 121 and/or the data lines 171, and the under-bridge metal pieces 172 are used for enhancing electrical connections between the gate lines 121 and the storage bridges 91 when irradiating a laser beam for such repair.

A plurality of subsidiary gate pads 95 and a plurality of subsidiary data pads 97 are formed on the passivation layer 180. The subsidiary gate pads 95 are connected to the gate pads 125 through the contact holes 182 in the passivation layer 180 and the gate insulating layer 140, while the subsidiary data pads 97 are connected to the data pads 179 through the contact holes 183 in the passivation layer 180.

A black matrix 220 for blocking light leakage is formed on an upper substrate 210. A plurality of red, green and blue color filters 230 are formed on the black matrix 220. A reference electrode 270 having a plurality of sets of cutouts 271, 272 and 273 are formed on the color filters 230. The reference electrode 270 is preferably made of a transparent conductor such as ITO or IZO.

Each set of the cutouts 271, 272 and 273 of the reference electrode 270 interpose the oblique cutouts 191 and 193 of the pixel electrode 190 between two adjacent cutouts 271, 272 and 273. Each cutout 271, 272 or 273 includes an oblique portion or portions parallel to the oblique cutouts 191 and 193 and transverse and longitudinal portions overlapping the edges of the pixel electrodes 190.

A basic structure of an LCD according to the present invention is prepared by aligning and combining the TFT array panel and the color filter panel having the above-described configurations and injecting liquid crystal material therebetween to be vertically aligned. When the TFT array panel and the color filter panel are aligned, the cutouts 191, 192 and 193 of the pixel electrodes 190 and the cutouts of the reference electrode 271, 272 and 273 divide the respective pixel areas into several small domains. These small domains are classified into four types based on average direction of major axes of liquid crystal molecules therein. The small domains are long such that their width and length can be distinguished. The width, which is the distance between the long edges of the domains, is established to a value equal to or less than 30 microns and this is expected to yield a response time equal to or less than 25 ms. However, in order to display motion pictures varying every frame, the response time is required to have a value equal to or less than 20 ms and thus the width of the domains is required to have a value equal to or less than 17 microns. In addition, the width of the domains is required to have a value equal to or less than 28 microns for keeping the amount of texture to be equal to or less than 0.03. The width of the domains is required to have a value equal to or less than 22 microns in order that third transmissive efficiency of a PVA mode LCD is equal to or larger than 90%. The width of the domains equal to or less than 22 microns keeps the amount of texture to be equal to or less than 0.02.

Meantime, the response time is related to the width of the cutouts. If the width of the cutouts is equal to or less than 24 microns, the response time is equal to or less than 25 ms, while the response time is equal to or less than 20 ms if the width of the cutouts is equal to or less than 5 microns.

The relations between the width of the domains, the response time, the amount of texture, and transmissive efficiency.

A PVA mode LCD realizes wide viewing angle by deforming electric field using cutouts. However, these cutouts distort the electric field and thus cause abnormal behavior of the liquid crystal molecules to generate texture, which reduces the transmissive efficiency and the response time. The present invention adjusts the width of the domains and the cutouts.

First, the response characteristic is described in detail.

The response characteristic, which is illustrated in Table 1, is obtained by using liquid crystal cells including small domains having width of 21, 23, 25 and 27 microns.

TABLE 1

width of domain

| | 21 | 23 | 25 | 27 |
|---|---|---|---|---|
| ON | 14.4 | 15.0 | 16.2 | 17.0 |
| OFF | 7.4 | 7.2 | 7.4 | 7.4 |
| ON + OFF | 21.8 | 22.2 | 23.6 | 24.4 |

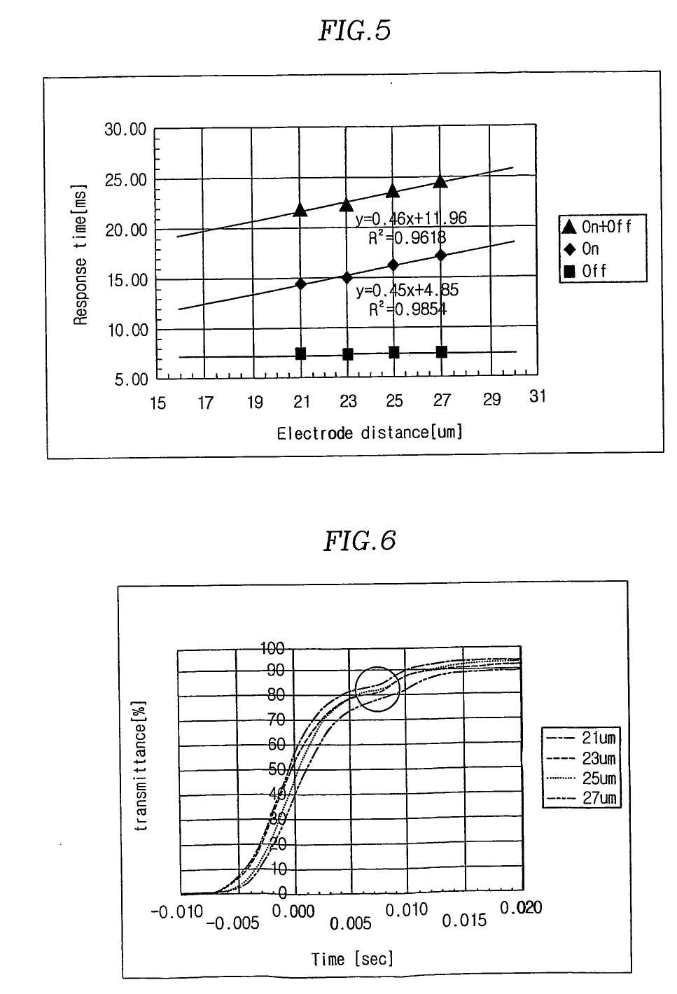

Referring to TABLE 1, the response time becomes small as the width of the small domains becomes narrow. In more detail, the OFF time remains substantially constant even though the width of the domains is narrowed, while the ON time is reduced when the width of the domains is narrowed such that the sum of the ON time and the OFF time is decreased. The result of TABLE 1 is shown in a graph of FIG. 5. It is expected from FIG. 5 that the response time is equal to or less than 20 ms when the width of the domains is equal to or less than about 17 microns.

Waveforms of response time as function of response time is described hereinafter.

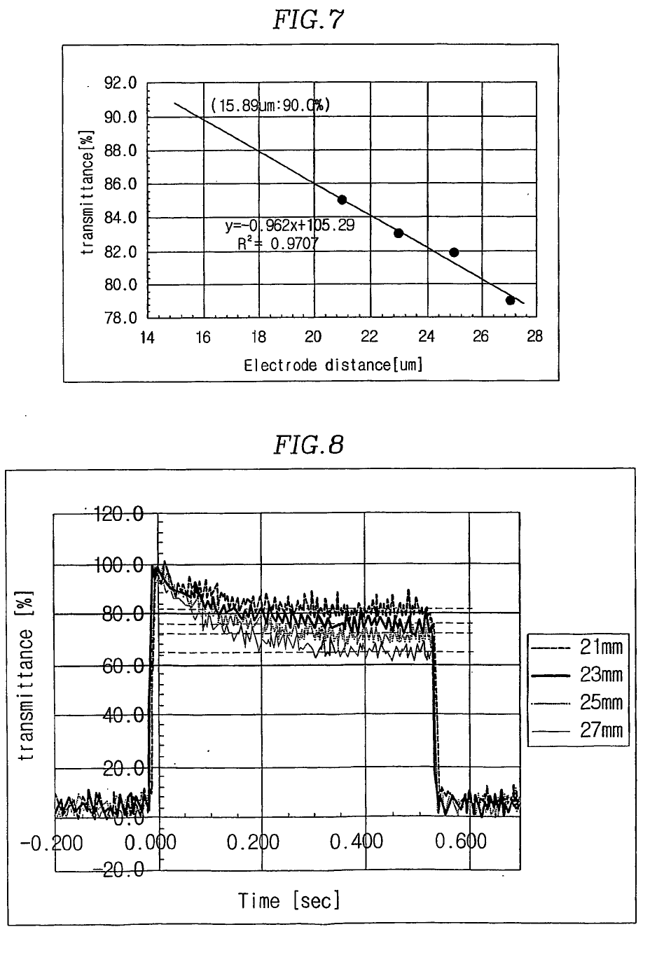

FIG. 6 is a graph showing response time for electrode width (i.e., width of the domains), and FIG. 7 is a graph representing ON cusp position depending on electrode width (i.e., width of the domains).

Referring to FIG. 6, the positions of the response time curves becomes high as the width of the domains becomes small. That is, the width of the domains and the position of the response time have an inversely-proportional relationship. Accordingly, the ON cusp position becomes high as the width of the domains is narrower as shown in FIG. 7. It is expected from FIG. 5 that the cusp is located at a point of 90% transmittance when the width of the domains is about 15.89 microns. The ON time is expected to be about 12 ms such that the total response time is 19.27 ms.

FIG. 8 is a graph showing response time of texture for electrode width (i.e., width of the domains).

A reverse polarizer was attached and the response time of texture and its quantitative characteristics was examined for the generation of textures depending on the width of the domains. The textures are classified into dynamic one and static one for quantitative analysis of textures. The dynamic texture is defined as an amount of the textures dynamically varying as time goes after voltage application, which equals to an area over a dotted line shown in FIG. 8. The static texture is defined as an amount of the stabilized textures, which equals to an area under a dotted line shown in FIG. 8. The dynamic texture and the static texture are expressed by:
Dynamic texture=variation of texture transmittance×time for texture stabilization×0.5;
Static texture=minimum transmittance of dynamic texture transmittance×width of texture response wave;
Total texture=dynamic texture+static texture; and

Time for texture stabilization=time for maximum texture transmittance−time for minimum texture transmittance.

| | electrode width | | | |
|---|---|---|---|---|
| | 21 | 23 | 25 | 27 |
| maximum texture transmittance | 0.0450 | 0.0500 | 0.0600 | 0.0700 |
| minimum texture transmittance | 0.0360 | 0.0370 | 0.0410 | 0.0450 |
| variation of texture transmittance | 0.0090 | 0.0130 | 0.0190 | 0.0250 |
| time for maximum texture | 0.0160 | 0.0010 | 0.0000 | 0.0000 |
| time for minimum texture | 0.1620 | 0.2130 | 0.2360 | 0.2860 |
| time for texture stabilization (sec) | 0.1460 | 0.2120 | 0.2360 | 0.2860 |
| dynamic texture | 0.0007 | 0.0014 | 0.0023 | 0.0036 |
| static texture | 0.0184 | 0.0195 | 0.0221 | 0.0239 |
| total texture | 0.0198 | 0.0214 | 0.0250 | 0.0282 |

Referring to TABLE 2, the generation of textures is reduced as the electrode distance is narrower. The texture transmittance is shown to be proportional to the electrode distance. The time for stabilizing texture after ON voltage application becomes longer as the electrode distance becomes large. That is, narrower electrode distance yields strong field effect to cause fast stabilization of the domains, and thus the response time becomes shorter. The total texture for realizing the response time equal to or less than 20 ms for a PVA mode LCD is equal to or less than 0.013. Referring to TABLE 2, the width of the domains is equal to or less than about 17 microns in order to obtain the total texture equal to or less than 0.013. In addition, the width of the domains for realizing the total texture equal to or less than 0.03 is preferably equal to or less than 28 microns, and that for realizing the total texture equal to or less than 0.02 is preferably equal to or less than 22 microns.

Now, transmissive efficiency is described in detail

First, the transmissive efficiency of an LCD is described. A multi-domain VA mode LCD such as a PVA mode LCD has poor transmittance characteristics due to so called brush or texture generated by the unstable alignment of liquid crystal, unlike other LCDs. The transmittance of a PVA mode LCD is determined by various factors such as aperture ratio as well as the shapes of cutouts.

The factors of light loss in a PVA mode LCD are classified into three types as shown in TABLE 3.

TABLE 3

| Factor | | |
|---|---|---|
| of light | detailed | |
| loss | element | description |
| first | aperture | It is generated due to mechanical causes |
| factor | ratio color | such as absorption by metal wire such as |
| | filter | black matrix or storage electrode wire, |
| | absorption | reflection by highly-refractive material |
| | polarizer | such as ITO and SiNx, and absorption by a |
| | | polarizer and color filters. However, |
| | | absorption by a front polarizer and area of |
| | | cutouts of ITO are not included in the first |
| | | factor. Since the absorption by the front |
| | | polarizer is related to Δnd of liquid |
| | | crystal, etc., it is hard to be considered |
| | | as a first factor. Furthermore, since the |
| | | area of the cutouts of ITO also transmits |
| | | light, it forms a part of an opening area. |
| second | Δn | It is related to electro-optical effect and |
| factor | cell gap | in particular related to effective Δnd |
| | driving | experienced by light. Δnd and the driving |
| | voltage | voltage are included into the same factor |
| | | since the light experiences Δnd depending |
| | | on the applied voltage. In particular, since |
| | | the driving voltage makes an effect on the |
| | | cutout areas, the second factor is |
| | | proportional to total average driving |
| | | voltage including the cutout area. |
| | | Accordingly, the wider cutout area reduces |
| | | the average driving voltage such that the |
| | | decrease of the transmittance due to the |
| | | second factor is increased and the second |
| | | efficiency is reduced. |
| third | texture | It means that the texture or the brush due to |
| factor | | unstable liquid crystal alignment decreases |
| | | luminance of light. It is related to domain |
| | | stability of a PVA mode LCD. |

In order to quantitative analysis of the above-described various factors related to the transmittance, transmissive efficiencies are defined by:
First transmissive efficiency=(transmissive luminance with only rear polarizer)/(luminance of light source);
Second transmissive efficiency=(transmissive luminance with normal polarizers+transmissive luminance with reverse polarizers)/(transmissive luminance with only rear polarizer);
Third transmissive efficiency=(transmissive luminance with normal polarizers)/(transmissive luminance with normal polarizers+transmissive luminance with reverse polarizers); and
Total transmittance=first transmissive efficiency×second transmissive efficiency×third transmissive efficiency.

Here, the term “with normal polarizers” means that the transmissive axes of the polarizers make an angle of 45 degrees or 135 degrees with behavior direction of the liquid crystal molecules, and the term “with reverse polarizers” means that the transmissive axes of the polarizers are aligned parallel to or perpendicular to behavior direction of the liquid crystal molecules. When the domains extend obliquely as in the embodiment of the present invention, the transmissive axes of the normal polarizers are aligned parallel or perpendicular to the gate lines, while the transmissive axes of the reverse polarizers make an angle of 45 degrees or 135 degrees with the gate lines.

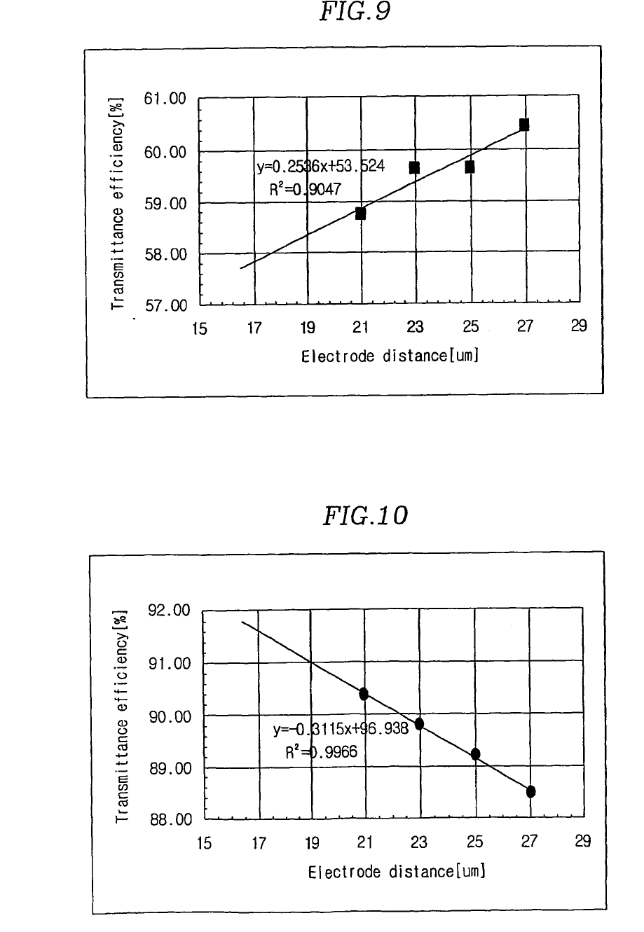

FIG. 9 shows the second transmissive efficiency depending on electrode distance (i.e., width of domains), and FIG. 10 shows the third transmissive efficiency depending on electrode distance (i.e., width of domains).

The first to third efficiencies obtained based on the above-described definition for the width of the domains by 21, 23, 25 and 27 microns are shown in TABLE 4.

TABLE 4

| width of | aperture | first | second | third | total | relative |
|---|---|---|---|---|---|---|
| domains | ratio | efficiency | efficiency | efficiency | transmittance | transmittance |
| (microns) | (%) | (%) | (%) | (%) | (%) | (%) |
| 21 | 38.7 | 7.25 | 58.76 | 90.37 | 3.85 | 99.50 |
| 23 | 39.4 | 7.24 | 59.61 | 89.78 | 3.88 | 100.30 |
| 25 | 40.0 | 7.26 | 59.63 | 89.21 | 3.86 | 99.70 |
| 27 | 40.6 | 7.23 | 60.44 | 88.48 | 3.87 | 100.00 |

TABLE 4 was obtained by varying only the width of the domains while remaining the width of the cutouts. The aperture ratio is shown to be proportional to the width of the domains. The first efficiency is hardly changed regardless of the variation of the width of the domains since absorption by metal wire such as a black matrix or a storage electrode wire, color filter resin, and a rear polarizer, reflection by highly-refractive material such as ITO and SiNx, and the area of the ITO cutouts are nearly the same. The second efficiency is related to electro-optical effect and in particular related to effective And experienced by light. Since the area occupied by the cutouts becomes large as the width of the domains becomes smaller, the average driving voltage for unit area is reduced to increase the light absorption due to the second factor, thereby decreasing the second efficiency. On the contrary, since the third efficiency means that the texture or the brush due to unstable liquid crystal alignment decreases luminance of light, the texture becomes decreased to increase the third efficiency as the width of the domains becomes reduced. As a result, the total transmittance is hardly changed regardless of the decrease of the width of the domains since the second efficiency is reduced while the third efficiency is increased.

The second and the third efficiencies described in TABLE 4 are shown in FIGS. 9 and 10. Referring to FIGS. 9 and 10, the aperture ratio, the first efficiency, the second efficiency, the third efficiency, and the total efficiency are 37.5%, 7.2%, 57.8%, 91.6%, and 3.84%, respectively, when the width of the domains is 17 microns. Accordingly, the response time is reduced to a value equal to or less than 20 ms without reducing the luminance.

Although the response time and the transmittance depending on the width of the domains are examined as described above, they also depend on the shapes of cutouts in case of a PVA mode LCD. Now, the response time and the transmittance depending on the shapes of cutouts are described.

FIG. 11 is a graph showing response characteristics as function of the width of cutouts of a common electrode in a PVA mode LCD.

TABLE 5 is obtained by measuring the response characteristics of liquid crystal cells provided with respective common electrodes having cutouts with widths (W2 in FIG. 3) of 9, 11, 13 and 15 microns.

TABLE 5

pattern width (microns)

| | 9 | 11 | 13 | 15 |
|---|---|---|---|---|
| ON | 13.20 | 14.20 | 14.50 | 14.60 |
| OFF | 7.80 | 7.60 | 7.90 | 8.00 |
| ON + OFF | 21.00 | 21.80 | 22.40 | 22.60 |

Referring to FIG. 5, the response time becomes short as the width of the cutouts becomes narrow. It is because that the reduced width of the cutouts increases the area of the electrode to strengthen the electric field applied to the liquid crystal molecules. In more detail, the ON time becomes short as the width of the cutouts becomes narrow although there is no improvement in the OFF time. FIG. 11 shows the result of TABLE 5. Referring to FIG. 11, the response time equal to or less than 20 ms is obtained when the width of the cutouts is equal to or less than 5 microns.

In the meantime, the width of the cutouts for generating fringe field satisfies the relation:
(width of cutouts)/(cell gap of liquid crystal layer)≧1.0.

Next, the transmittance depending on the width of the cutouts is described.

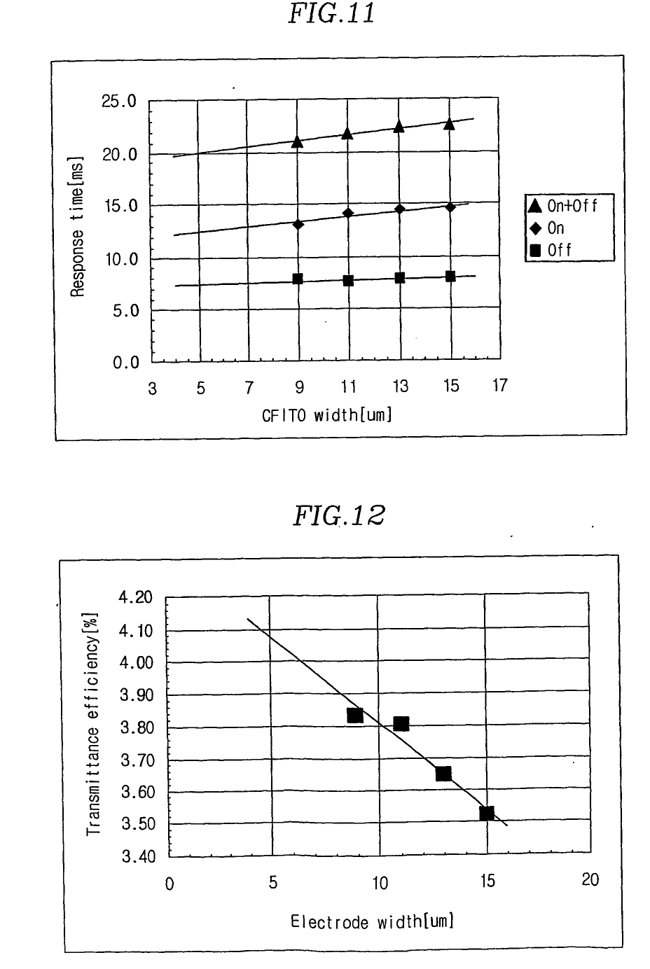

FIG. 12 is a graph showing the transmittance as function of the width of cutouts of a common electrode in a PVA mode LCD.

TABLE 6 is obtained by measuring the response characteristics of liquid crystal cells provided with respective common electrodes having cutouts with widths (W2 in FIG. 3) of 9, 11, 13 and 15 microns.

TABLE 6

| width of domain | aperture ratio | transmittance | relative |
|---|---|---|---|
| (microns) | (%) | (%) | transmittance (%) |
| 9 | 41.9 | 3.83 | 108.81 |
| 11 | 39.4 | 3.80 | 107.95 |
| 13 | 37.3 | 3.65 | 103.69 |
| 15 | 35.6 | 3.52 | 100.00 |

Referring to TABLE 6, the aperture ratio and the transmittance increase as the width of the domains becomes narrow. FIG. 11 shows the result of TABLE 6. Referring to FIG. 12, the transmittance is improved by about 16% when the width of the domains is equal to 5 microns.

Although the measurement in the above-described example is performed with varying the width of the cutouts of a common electrode, similar results can be obtained when varying the width of the cutouts of pixel electrodes.

In addition, when the cutouts as the domain partitioning member are substituted with dielectric protrusions, similar results can be obtained.

As described above, the response time is improved by adjusting the width of the domains and the response time and the transmittance are improved by adjusting the width of the cutouts.

Now, methods of manufacturing a TFT array panel having the above-described structure and advantages according to an embodiment of the present invention is described in detail.

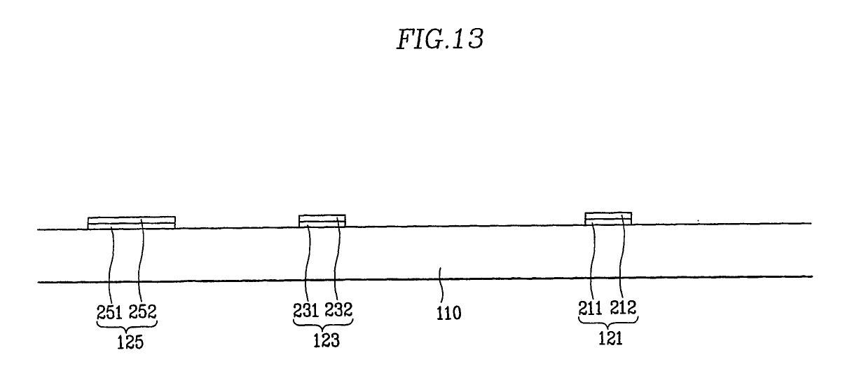

First, a manufacturing method using five photo masks is described with reference FIGS. 13 to 17.

First, referring to FIGS. 13 to 17, a method using five photo-masks will be described.

As shown in FIG. 13, a first gate wire layer 211, 231 and 251 preferably made of Cr or Mo alloy having excellent physical and chemical characteristics and a second gate wire layer 212, 232 and 252 preferably made of Al or Ag alloy having a low resistivity are deposited on a substrate 110 and patterned to form a gate wire including a plurality of gate lines 121, a plurality of gate electrodes 123 and a plurality of gate pads 125 and extending substantially in the transverse direction. At this time, although not shown, a storage electrode wire is also formed (A First Mask).

For the first gate wire layer 211, 231 and 251 of Mo alloy and the second gate wire layer 212, 232 and 252 of Ag alloy, both layers are etched by an etchant for Al alloy such as a mixture of phosphoric add, nitric add, acetic acid and deionized water. Thus, the formation of the gate wire 121, 123 and 125 including double layers is completed by using a single etching process. Since the etching ratio of the mixture of phosphoric add, nitric acid, acetic add and deionized water for Ag alloy is higher than that for Mo alloy, a taper angle of 30 degrees required for the gate wire can be obtained.

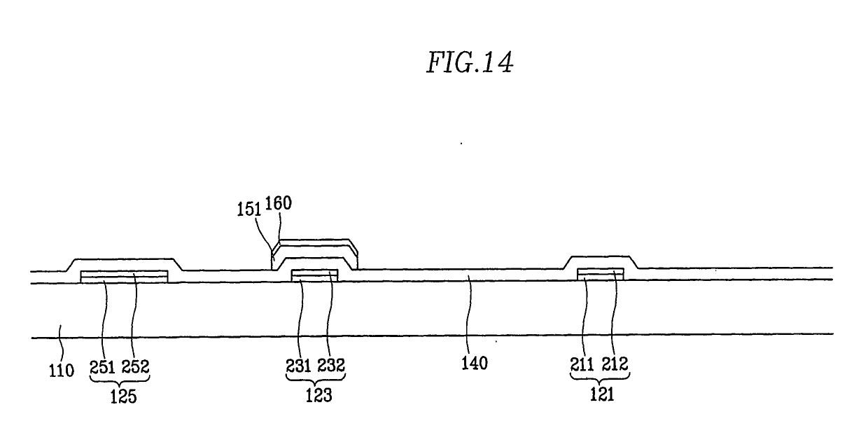

Next, as shown in FIG. 14, three layers, a gate insulating layer 140 preferably made of SiNx, an amorphous silicon layer and a doped amorphous silicon layer are deposited sequentially, and the amorphous silicon layer and the doped amorphous silicon layer are photo-etched together to form a semiconductor layer 151 and an ohmic contact layer 160 on the gate insulating layer 140 opposite the gate electrodes 123 (A Second Mask).

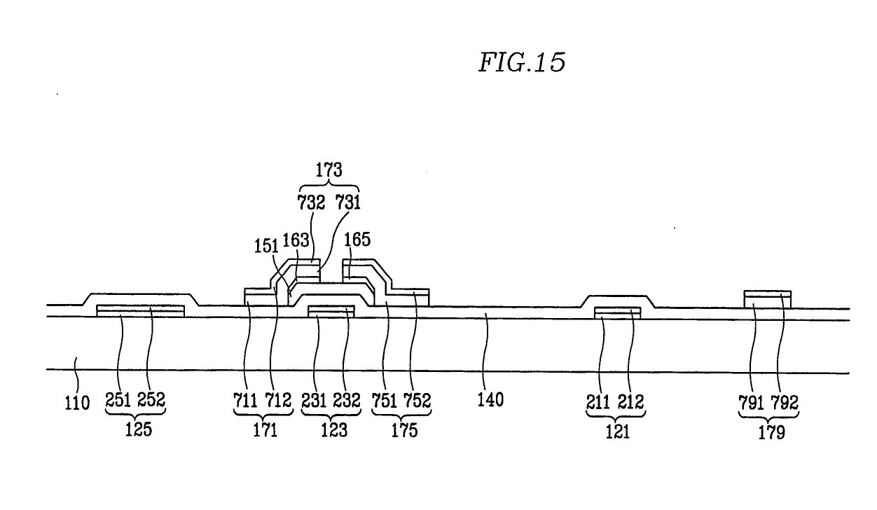

Subsequently, as shown in FIG. 15, a first data wire layer 711, 731, 751 and 791 preferably made of Cr or Mo alloy and a second data wire layer 712, 732, 752 and 792 preferably made of Al or Ag alloy are deposited and photo-etched to form a data wire. The data wire include a plurality of data lines 171 intersecting the gate line 121, a plurality of source electrodes 173 connected to the data lines 171 and extending onto the gate electrodes 121, a plurality of data pads 179 connected to one ends of the data lines 171 and a plurality of drain electrodes 175 separated from the source electrodes 173 and opposite the source electrodes 173 with respect to the gate electrodes 121 (A Third Mask).

Thereafter, portions of the doped amorphous silicon layer pattern 160, which are not covered by the data wire 171, 173, 175 and 179, are etched such that the doped amorphous silicon layer pattern 160 is separated into two portions 163 and 165 opposite each other with respect to the gate electrodes 123 to expose portions of the semiconductor pattern 151 between the two portions of the doped amorphous silicon layer 163 and 165. Oxygen plasma treatment is preferably performed in order to stabilize the exposed surfaces of the semiconductor layer 151.

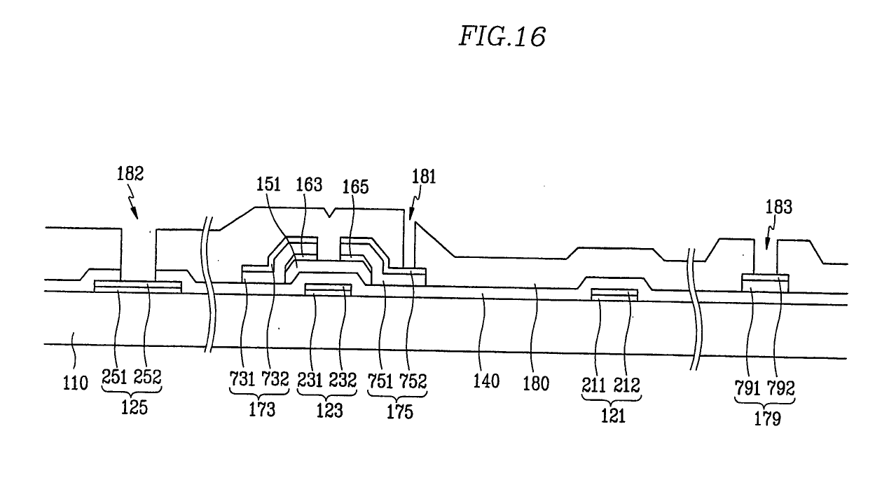

Next, as shown in FIG. 16, a passivation layer 180 is formed by growing a a-Si:C:O film or a a-Si:O:F film by chemical vapor deposition (“CVD”), by depositing an inorganic insulating film such as SiNx, or by coating an organic insulating film such as acryl-based material. The deposition of the a-Si:C:O film is performed by using SiH(CH₃)₃, SiO₂(CH₃)₄, (SiH)₄O₄(CH₃)₄, Si(C₂H₅O)₄, etc., in gaseous states as a basic source, and flowing a gas mixture of an oxidizer such as N₂O and O₂ and Ar or He. The deposition of the a-Si:O:F film is performed in the flow of a gas mixture of O₂ and SiH₄, SiF₄, etc. CF₄ may be added as an auxiliary source of fluorine. (A Second Mask)

The passivation layer 180 is patterned together with the gate insulating layer 140 by a photo etching process to form a plurality of contact holes 181, 182 and 183 exposing the gate pads 125, the drain electrodes 175 and the data pads 179. Here, the planar shapes of the contact holes 181, 182 and 183 are polygonal or circular. It is preferable that the area of each of the contact holes 181 and 183 exposing the pads 125 and 179 is equal to or larger than 0.5 mm×15 μm and equal to or less than 2 mm×60 μm. Although not shown, a plurality of contact holes for contacting storage bridges with the storage electrode lines and the storage electrodes are also formed in this step (A Fourth Mask).

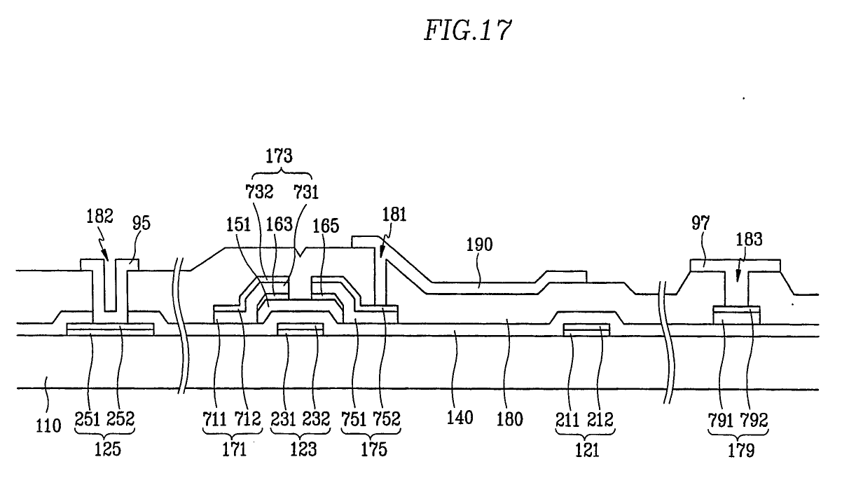

Finally, as shown in FIG. 17, an ITO layer or an IZO layer is deposited and photo-etched to a plurality of pixel electrodes 190, a plurality of auxiliary gate pads 95 and a plurality of auxiliary data pads 97. Each pixel electrode 190 is connected to the drain electrode 175 via the first contact hole 181, and each of the auxiliary gate pad 95 and the auxiliary data pad 97 are connected to the gate pad 95 and the data pad 97 via the second and the third contact holes 182 and 183. A pre-heating process using nitrogen gas is preferably performed before depositing ITO or IZO. This is required for preventing the formation of metal oxides on the exposed portions of the metal layers through the contact holes 181, 182 and 183. Although not shown, a plurality of storage bridges is also formed in this step, and a photo-mask is designed such that the cutouts of the pixel electrodes 190 have an inversion symmetry with respect to the data lines 171 (A Fifth Mask).

Now, a method of manufacturing a TFT array panel using four photo-masks according to an embodiment of the present invention will be described.

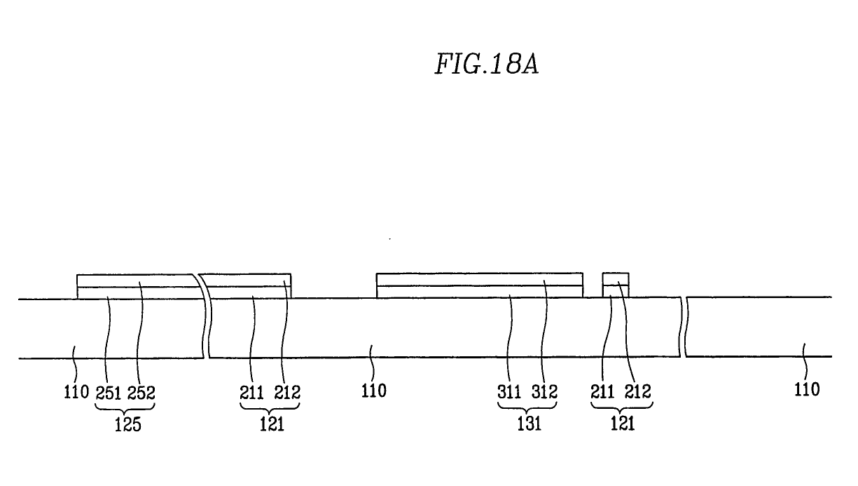

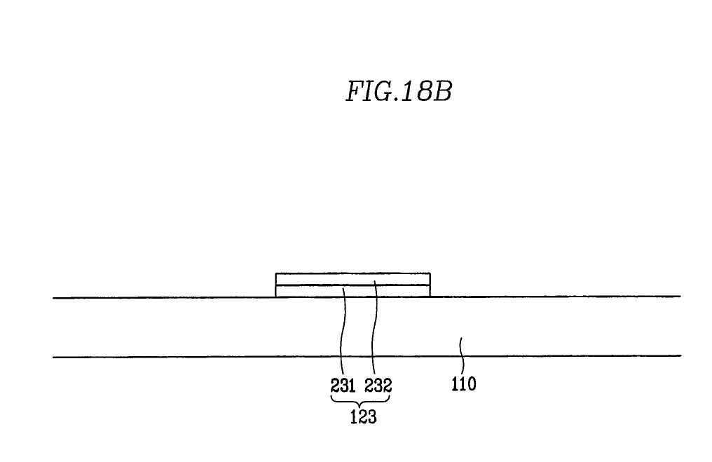

FIGS. 18A and 18B to FIGS. 26A and 26B are sectional views of a TFT array panel for an LCD sequentially showing the steps of a manufacturing method thereof using four masks.

First, as shown in FIGS. 18A and 18B, like the first embodiment, a first gate wire layer 211, 231 and 251 preferably made of Cr or Mo alloy having excellent physical and chemical characteristics and a second gate wire layer 212, 232 and 252 preferably made of Al or Ag alloy having a low resistivity are deposited on a substrate 110 and patterned to form a gate wire including a plurality of gate lines 121, a plurality of gate electrodes 123 and a plurality of gate pads 125 and a storage electrode wire (A First Mask).

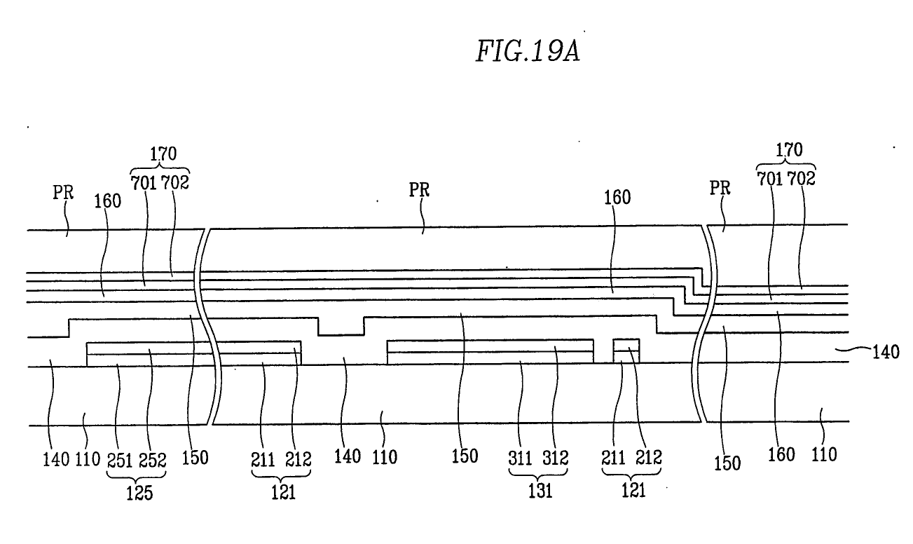

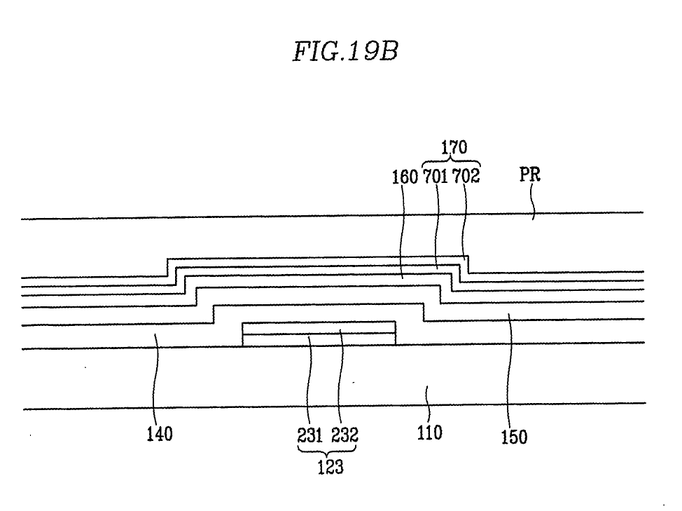

Next, as shown in FIGS. 19A and 19B, a gate insulating layer 140 of SiNx, a semiconductor layer 150, and a contact layer 160 are sequentially deposited by CVD such that the layers 30, 40 and 50 bear thickness of 1,500-5,000 Å, 500-2,000 Å and 300-600 Å, respectively. A first conductive film 701 preferably made of Cr or Mo alloy and a second conductive film 702 preferably made of Al or Ag alloy are deposited by sputtering to form a conductive layer 170. Thereafter, a photoresist film PR with the thickness of 1-2 μm is coated thereon.

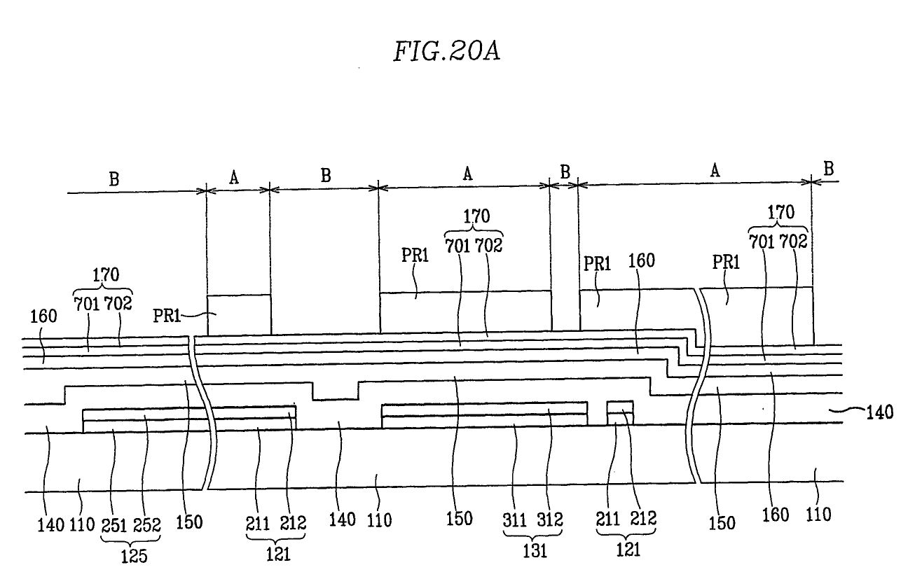

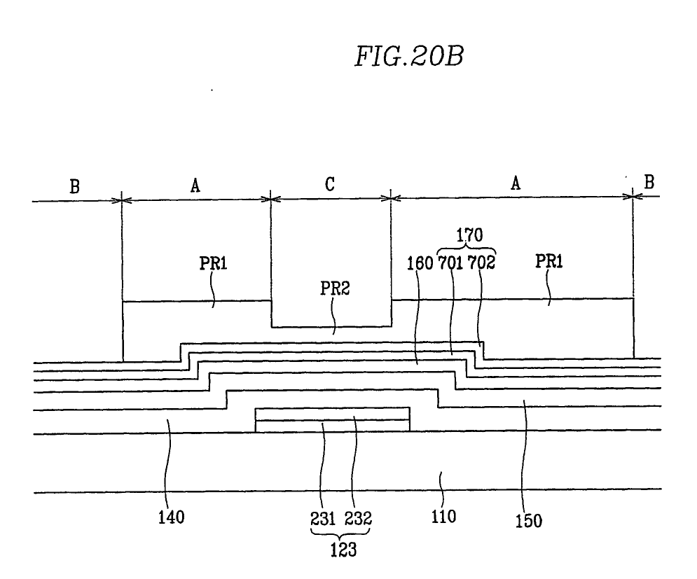

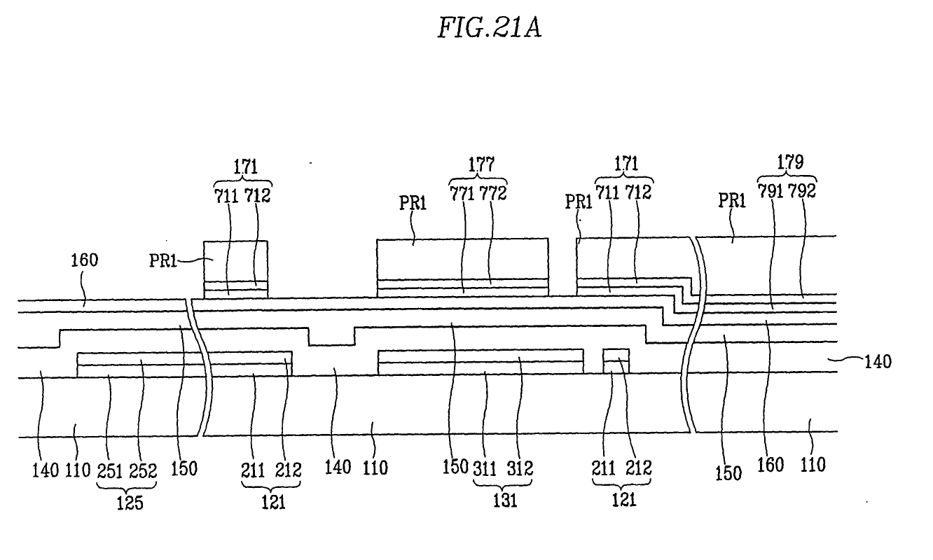

Subsequently, the photoresist film PR is exposed to light through a mask, and developed to form a photoresist pattern PR2 and PR1 as shown in FIGS. 20A and 20B. Second portions PR2 of the photoresist pattern PR2 and PR1, which are located on channel areas C of TFTs between source and drain electrodes 173 and 175, are established to bear thickness smaller than that of the first portions PR1 on data areas A where the data wire is formed. The portions of the photoresist film on the remaining area B are removed. The thickness ratio of the second portions PR2 on the channel areas C to the first portions PR1 on the data areas A is adjusted depending upon the etching conditions in the etching steps to be described later. It is preferable that the thickness of the second portions PR2 is equal to or less than half of the thickness of the first portions PR1, in particular, equal to or less than 4,000 Å.

The position-dependent thickness of the photoresist film is obtained by several techniques. In order to adjust the amount of light exposure in the areas C, a slit pattern, a lattice pattern or translucent films are provided on a mask.

When using a slit pattern, it is preferable that the width of the portions between the slits or the distance between the portions, i.e., the width of the slits is smaller than the resolution of an exposer used for the photolithography. In case of using translucent films, thin films with different transmittances or with different thicknesses may be used to adjust the transmittance of the mask.

When the photoresistive film is irradiated with light through such a mask, polymers of the portions directly exposed to the light are almost completely decomposed, and those of the portions facing the slit pattern or the translucent films are not completely decomposed due to the small amount of light exposure. The polymers of the portions blocked by light-blocking films are hardly decomposed. Development of the photoresistive film makes the portions having the polymers, which are not decomposed, to be left, and makes the portions exposed to the smaller light irradiation to be thinner than the portions which do not experience the light exposure. Here, it is required not to make the exposure time long enough to decompose all the molecules.

The thin portions PR2 of the photoresist pattern may be obtained by performing a reflow process to flow a reflowable photoresist film into the areas without the photoresist film after exposing to light and developing the photoresist film, using a usual mask with transmissive areas completely transmitting the light and blocking areas completely blocking the light.

Thereafter, the photoresist pattern PR2 and the underlying layers, i.e., the conductive layer 170, the contact layer 150 and the semiconductor layer 150 are etched such that a data wire and the underlying layers are left over on the data areas A, only the semiconductor layer is left over on the channel areas C, and all of the three layers 170, 160 and 150 are removed from the remaining areas B to expose the gate insulating layer 140.

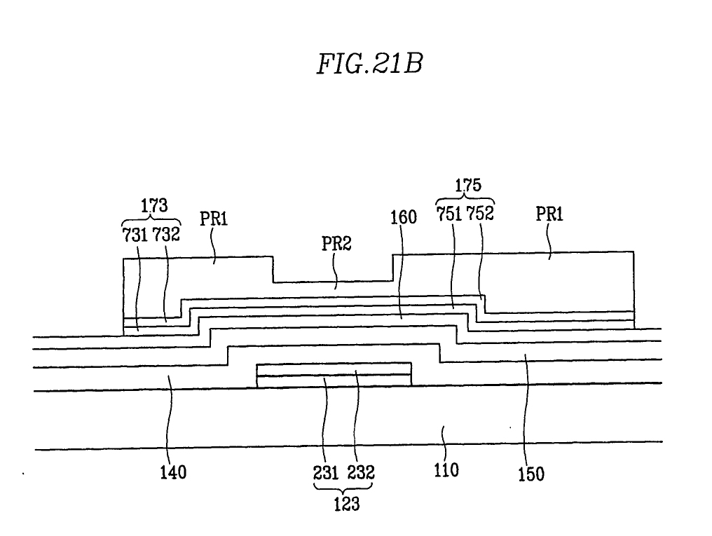

As shown in FIGS. 21A and 21B, the exposed portions of the conductive layer 170 on the areas B are removed to expose the underlying portions of the contact layer 150. In this step, both dry etching and wet etching is selectively used and preferably performed under the condition that the conductive layer 170 is selectively etched while the photoresist pattern PR1 and PR2 is hardly etched. However, an etching condition capable of etching the photoresist pattern PR1 and PR2 as well as the conductive layer 170 would be suitable for dry etching since it is difficult to find a condition for selectively etching only the conductive layer 170 while not etching the photoresist pattern PR1 and PR2. In this case, the second portion PR2 should have relatively thick compared with that for wet etching in order to prevent the exposure of the underlying conductive layer 170 through the etching.

Consequently, as shown in FIGS. 21A and 21B, portions 171, 173, 175 and 179 of the conductive layer on the channel areas C and the data areas A, and a storage capacitor electrodes 177 are left over, while portions of the conductive layer 170 on the remaining areas B is removed out to expose the underlying portions of the contact layer 150. The remaining conductor patterns 171, 173, 175 and 179 have substantially the same shapes as the data wire 171, 173, 175 and 179 except that the source and the drain electrodes 173 and 175 are still connected without separation. When using the dry etching, the photoresist pattern PR1 and PR2 are also etched to a predetermined thickness.

Next, as shown in FIGS. 21A and 21B, the exposed portions of the contact layer 150 on the areas B and the underlying portions of the semiconductor layer 150 are simultaneously removed by dry etching together with the second photoresist portions PR2. The etch is preferably made in a condition that the photoresist pattern PR1 and PR2, the contact layer 150 and the semiconductor layer 150 are simultaneously etched while the gate insulating layer 140 is not etched. (It is noted that the semiconductor layer and the intermediate layer have no etching selectivity.) Particularly, the etching ratios of the photoresist pattern PR1 and PR2 and the semiconductor layer 150 are preferably equal to each other. For example, the film and the layer are etched to substantially the same thickness using a gas mixture of SF₆ and HCl or a gas mixture of SF₆ and O₂. For the equal etching ratios of the photoresist pattern PR1 and PR2 and the semiconductor layer 150, the thickness of the second portions PR2 is preferably equal to or less than the sum of the thicknesses of the semiconductor layer 150 and the contact layer 150.

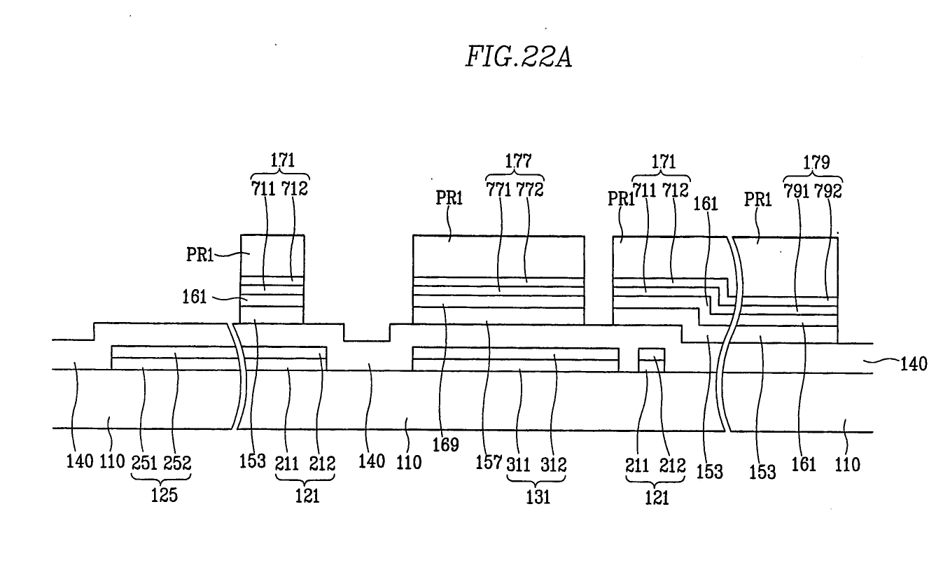

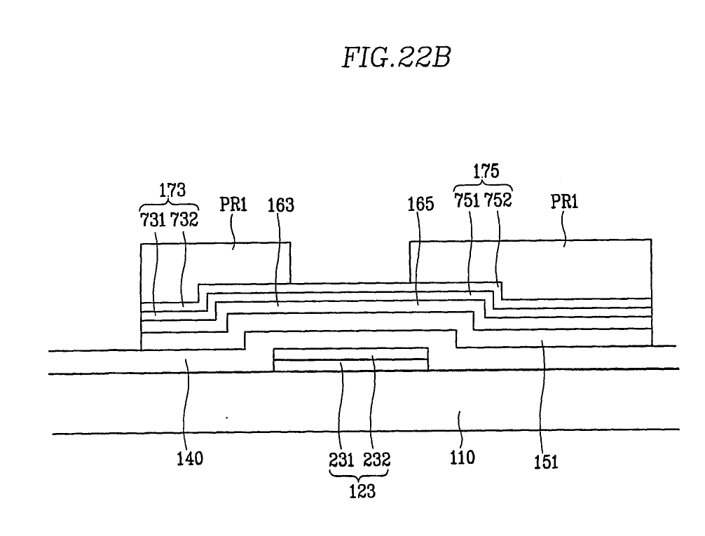

In this way, as shown in FIGS. 22A and 22B, the second portions PR2 on the channel areas C are removed to expose the source/drain conductor pattern 173 and 175, and the portions of the contact layer 150 and the semiconductor layer 150 on the areas B are removed to expose the underlying portions of the gate insulating layer 140. Meanwhile, the first portions PR1 on the data areas A are also etched to have reduced thickness. In this step, the formation of a semiconductor pattern 151, 153 and 157 are completed. A contact layer 161, 163 and 165 and 169 is formed on the semiconductor pattern 151, 153 and 157.

Residual photoresist remained on the surface of the source/drain conductor pattern 173 and 175 on the channel areas C is then removed by ashing.

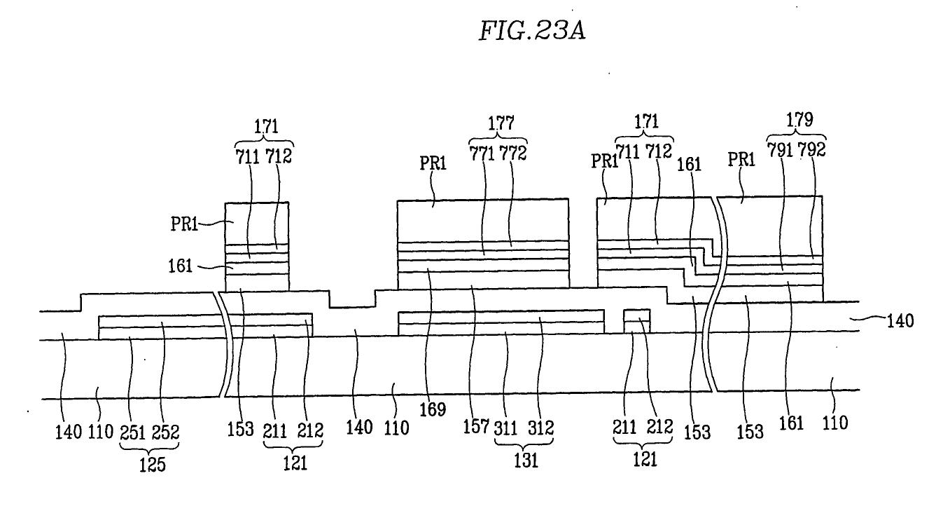

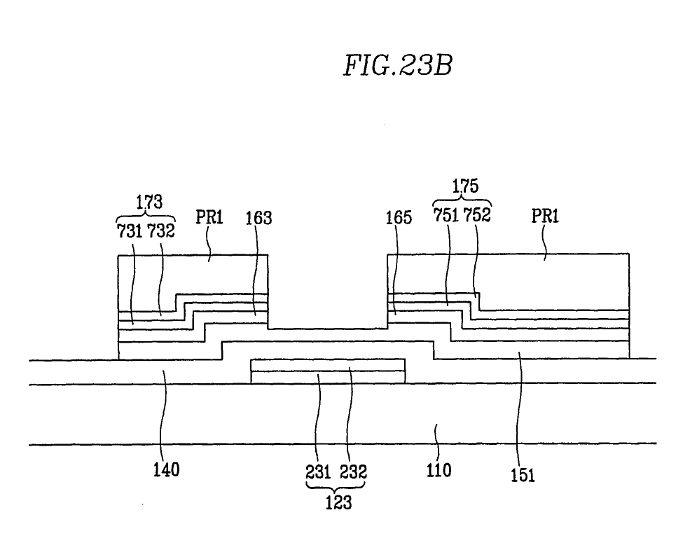

Subsequently, as shown in FIGS. 23A and 23B, the exposed portions of the source/drain conductor pattern 173 and 175 on the channel areas C and the underlying portions of the source/drain contact layer pattern 163 and 165 are etched to be removed. Dry etching may be applied to both of the source/drain conductor pattern 173 and 175 and the source/drain contact layer pattern 163 and 165. Alternatively, wet etching is applied to the source/drain conductor pattern 173 and 175 while dry etching is applied to the source/drain contact layer pattern 163 and 165. In the former case, it is preferable that the conductor pattern 173 and 175 and the contact layer pattern 1631 and 165 are etched under large etching selectivity because, if not large, it is not easy to find the end point of etching and in turn, it is not easy to adjust the thickness of the semiconductor pattern 151 left on the channel areas C. In the latter case alternately performing dry etch and wet etch, the lateral sides of the source/drain conductor pattern 173 and 175 subject to wet etch are etched, while those of the contact layer pattern 163 and 165 subject to dry etch are hardly etched, thereby obtaining the stepwise lateral sides. Examples of etching gases used for etching the conductor pattern 173 and 175 and the contact layer 163 and 165 are a gas mixture of CF₄ and HCl and a gas mixture of CF₄ and O₂. The gas mixture of CF₄ and O₂ leaves the semiconductor pattern 151 with even thickness. At this time, as shown in FIG. 23B, top portions of the semiconductor pattern 151 may be removed to cause thickness reduction, and the first portions PR1 of the photoresist pattern is etched to a predetermined thickness. The etching is performed under the condition that the gate insulating layer 140 is hardly etched, and it is preferable that the photoresist film is so thick to prevent the first portion PR1 from being etched to expose the underlying data wire 171, 173, 175 and 179 and the underlying storage capacitor electrodes 177.

In this way, the source and the drain electrodes 173 and 175 are separated from each other while completing the formation of the data wire 171, 173, 175 and 179 and the underlying contact layer pattern 161, 163 and 165.

Finally, the first portions PR1 remained on the data areas A are removed. However, the removal of the first portions PR1 may be made between the removal of the portions of the source/drain conductor pattern 173 and 175 on the channel areas C and the removal of the underlying portions of the contact layer pattern 163 and 165.

As described above, dry etch and wet etch are alternately performed or only dry etch is used. Although the latter process using only one type of etch is relatively simple, it is hard to find appropriate etching conditions. On the contrary, the former process enables to find proper etching conditions while it is rather complicated.

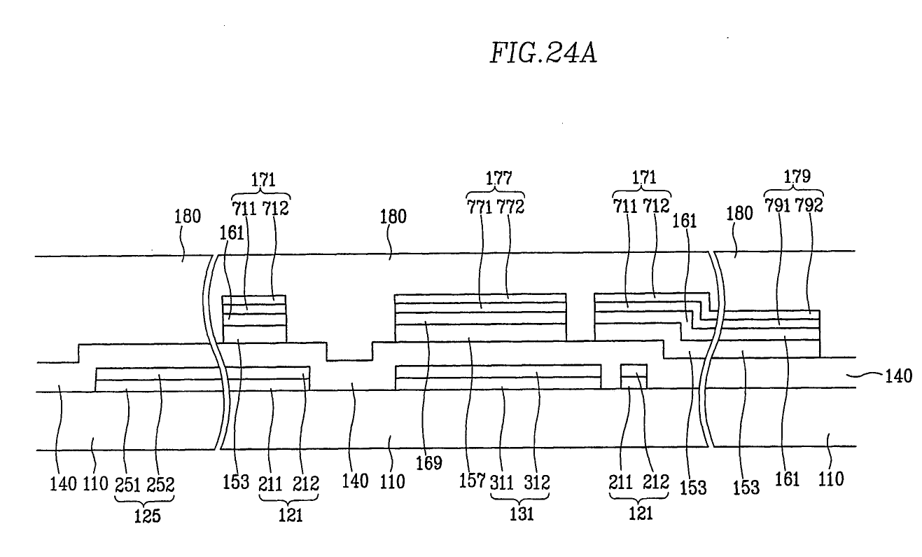

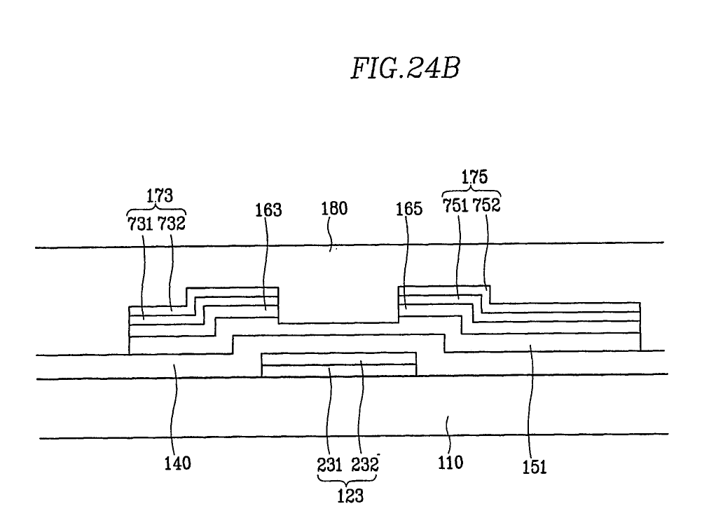

Next, as shown in FIGS. 24A and 24B, a passivation layer 180 is formed by growing a a-Si:C:O film or a a-Si:O:F film by chemical vapor deposition (“CVD”), by depositing an inorganic insulating film such as SiNx, or by coating an organic insulating film such as acryl-based material. The deposition of the a-Si:C:O film is performed by using SiH(CH₃)₃, SiO₂(CH₃)₄, (SiH)₄O₄(CH₃)₄, Si(C₂H₅O)₄, etc., in gaseous states as a basic source, and flowing a gas mixture of an oxidizer such as N₂O and O₂ and Ar or He. The deposition of the a-Si:O:F film is performed in the flow of a gas mixture of O₂ and SiH, SiF₄, etc. CF₄ may be added as an auxiliary source of fluorine. (A Second Mask).

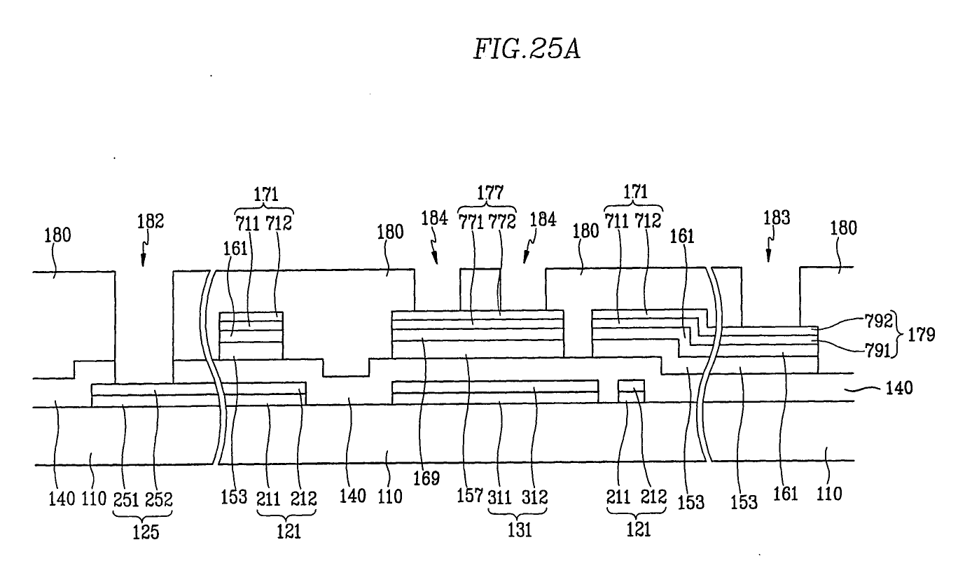

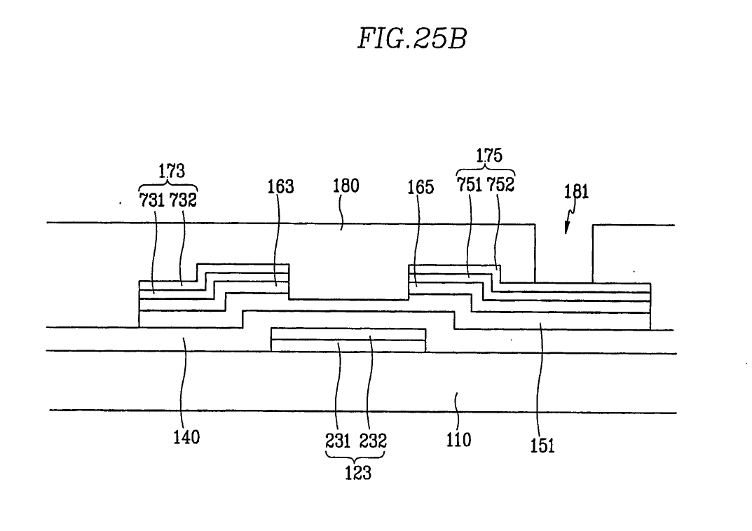

Subsequently, as shown in FIGS. 25A and 25B, the passivation layer 180 is photo-etched together with the gate insulating layer 140 to form a plurality of contact holes 181, 182, 183 and 184 exposing the drain electrodes 175, the gate pads 125 and the data pads 179 and the storage capacitor electrodes 177. It is preferable that the area of each of the contact holes 181 and 183 exposing the pads 125 and 179 is equal to or larger than 0.5 mm×15 μm and equal to or less than 2 mm×60 μm Although not shown, a plurality of contact holes for contacting storage bridges with the storage electrode lines and the storage electrodes are also formed in this step (A Third Mask).

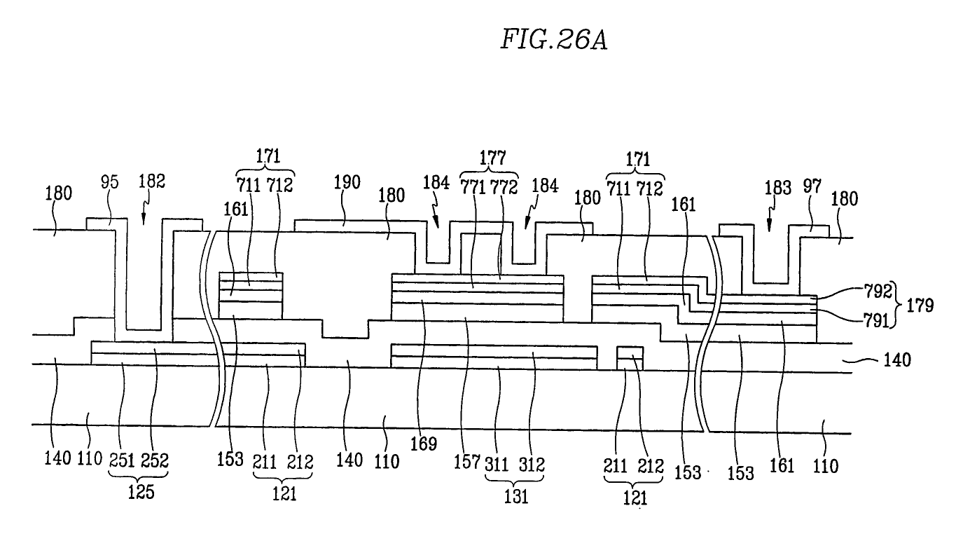

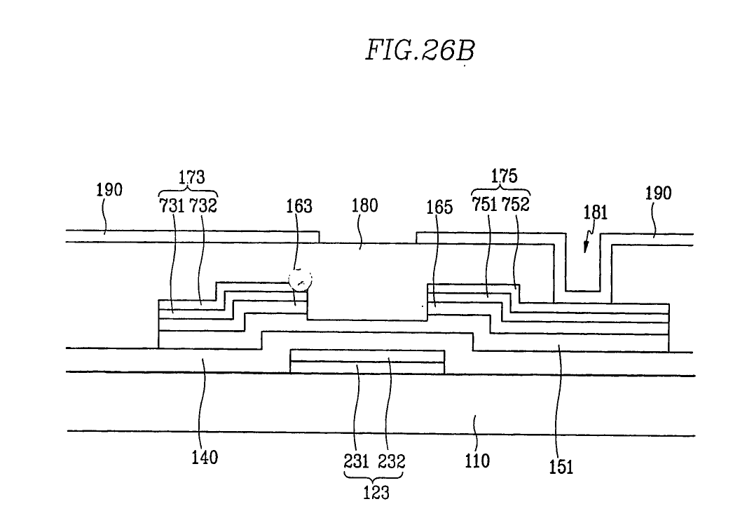

Finally, as shown in FIGS. 26A and 26B, an ITO layer or an IZO layer is deposited and photo-etched to a plurality of pixel electrodes 190, a plurality of auxiliary gate pads 95 and a plurality of auxiliary data pads 97. Each pixel electrode 190 is connected to the drain electrode 175 and the storage capacitor electrode 177, and each of the auxiliary gate pad 95 and the auxiliary data pad 97 are connected to the gate pad 95 and the data pad 97. Although not shown, a plurality of storage bridges is also formed in this step, and a photo-mask is designed such that the cutouts of the pixel electrodes 190 have an inversion symmetry with respect to the data lines 171 (A Fourth Mask).

Since the pixel electrodes 190, the auxiliary gate pads 95 and the auxiliary data pads 97 made of IZO is formed by using a Cr etchant, it is possible to prevent the corrosion of the exposed portions of the data wire or the gate wire through the contact holes during the photo etching step for forming the pixel electrodes 190, the auxiliary gate pads 95 and the auxiliary data pads 97. An example of such etchant is HNO₃/(NH₄)₂Ce(NO₃)₆/H₂O. Deposition of IZO in a temperature range between a room temperature and about 200° C. is preferred for minimizing the contact resistance at the contacts. It is preferable that a target used for forming an IZO film includes In₂O₃ and ZnO and an amount of ZnO contained therein is in a range of 15-29 at %.

A pre-heating process using nitrogen gas is preferably performed before depositing ITO or IZO. This is required for preventing the formation of metal oxides on the exposed portions of the metal layers through the contact holes 181, 182, 183 and 184.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims. Especially, a variety of modifications may be made in arrangements of cutouts provided at the pixel electrodes and the reference electrode.

The above-described configurations improve the aperture ratio of the LCD and reduce the distortion of the image signals.

What is claimed is:

1. A liquid crystal display comprising:
a first insulating substrate;
a gate line formed on the first insulating substrate;
a gate insulating layer formed on the gate line;
a data line formed on the gate insulating layer;
a passivation layer formed on the data line;
a pixel electrode formed on the passivation layer;
a second insulating substrate facing the first insulating substrate;
a common electrode formed on the second insulating substrate;
a first domain partitioning member formed on at least one of the first and the second insulating substrates; and
a second domain partitioning member formed on at least one of the first and the second insulating substrates and partitioning a pixel region into a plurality of domains along with the first domain partitioning member,
wherein width of the domains is equal to or less than 30 microns.

2. The liquid crystal display of claim 1, wherein the width of the domains is equal to or less than 28 microns.

3. The liquid crystal display of claim 2, wherein the width of the domains is equal to or less than 22 microns.

4. The liquid crystal display of claim 3, wherein the width of the domains is equal to or less than 17 microns.

5. The liquid crystal display of claim 1, wherein the first domain partitioning member includes a cutout provided at the pixel electrode and the second domain partitioning member includes a cutout provided at the common electrode.

6. The liquid crystal display of claim 5, wherein the width of the second domain partitioning member is equal to or less than 24 microns.

7. The liquid crystal display of claim 6, wherein the width of the second domain partitioning member is equal to or less than 5 microns.

8. The liquid crystal display of claim 1, wherein extension of the domains makes an angle of 45 degrees or 135 degrees with the gate line.

9. The liquid crystal display of claim 1, wherein the data line has a triple-layered structure including an amorphous silicon layer, a doped amorphous silicon layer, and a metal layer.

10. A liquid crystal display comprising:
a first insulating substrate;
a gate wire formed on the first insulating substrate and including a gate line, a gate electrode connected to the gate line, and a gate pad connected to the gate line;
a storage electrode wire formed on the first insulating substrate and including a storage electrode line and a storage electrode branched from the storage electrode lines;
a gate insulating layer formed on the gate wire and the storage electrode wire;
an amorphous silicon layer formed on the gate insulating layer;
a contact layer formed on the amorphous silicon layer;
a data wire formed on the contact layer and including a data line intersecting the gate line, a data pad connected to the data line, a source electrode connected to the data line and located adjacent to the gate electrode, and a drain electrode located opposite the source electrode with respect to the gate electrode;
a passivation layer formed on the data wire;
a pixel electrode formed on the passivation layer, connected to the drain electrode, and having a first cutout pattern;
facing the first insulating substrate;
a black matrix formed on the second insulating layer and defining a pixel area;
a color filter formed on the pixel area; and
a common electrode formed on the color filter and having a second cutout pattern,
wherein width of the second cutout pattern is equal to or less than 24 microns.

11. The liquid crystal display of claim 10, further comprising a liquid crystal layer interposed between the first insulating substrate and the second insulating substrate, wherein liquid crystal molecules included in the liquid crystal layer are aligned perpendicular to the first insulating substrate in absence of electric field.

12. The liquid crystal display of claim 11, wherein the width of the second cutout pattern is equal to or less than 5 microns.

13. The liquid crystal display of claim 11, wherein the width of the first and the second cutout patterns is equal to or less than cell gap of the liquid crystal layer.

14. The liquid crystal display of claim 11, wherein the first and the second cutout patterns partition a pixel region into a plurality of domains, and the width of the domains is equal to or less than 28 microns.

15. The liquid crystal display of claim 14, wherein the width of the domains is equal to or less than 22 microns.

16. The liquid crystal display of claim 15, wherein the width of the domains is equal to or less than 17 microns.

17. The liquid crystal display of claim 11, further comprising an overcoat interposed between the color filter and a common electrode.
